(19) United States
(12) Patent Application Publication
(10) Pub. No.: US 2020/0132056 A1
(43) Pub. Date: Apr. 30, 2020

(54) ACTUATOR

(71) Applicant: Stabilus GmbH, Koblenz (DE)

(72) Inventors: Michael Auer, Kobern - Gondorf (DE); Martin Neitzert, Urbach (DE); Kathrin Kronz, Mittelstrimmig (DE); Axel Knopp, Eitelborn (DE)

(73) Assignee: Stabilus GmbH, Koblenz (DE)

(21) Appl. No.: 16/664,210

(22) Filed: Oct. 25, 2019

(30) Foreign Application Priority Data
Oct. 29, 2018 (DE) 10 2018 218 510.7

(51) Int. Cl. F03G 1/06; F03G 1/02; F03G 1/10; F16C 29/02

(52) U.S. Cl. CPC F03G 1/06; F03G 1/02; F03G 2730/02; F16C 29/02; F03G 2730/07; F03G 1/10

(57) ABSTRACT

The present invention relates to an actuator (10) comprising a first connection unit, a second connection unit, a spring arranged between the first and second connection unit, a guide tube (12) arranged inside the spring, and a dip rod configured to be displaceable relative to the guide tube (12) so that it dips into the guide tube (12), wherein the dip rod is mounted in a guide bush (14), characterised in that the guide bush (14) comprises a recess (18) in the circumferential direction of the guide bush (14) adapted to accommodate a tapered end of the guide tube (12).

### BRIEF DESCRIPTION OF THE DRAWINGS

FIG. 1 is a cross-sectional side view of one end of a guide tube of an actuator, according to at least one example.

FIG. 2 is a cross-sectional side view of a guide brush, according to at least one example.

FIG. 3a shows a prior art actuator.

FIG. 3b shows an actuator according to the present disclosure, according to at least one example.

### DETAILED DESCRIPTION

The invention relates to an actuator comprising a first connection unit for connecting the actuator to a first parent assembly, a second connection unit for connecting the actuator to a second parent assembly, a spring arranged between the first and the second connection unit whose length is variable depending on a change in the distance between the first connection unit and the second connection unit, a guide tube which is arranged within the spring and, at least translationally, fixedly connected to the first connection unit, and a dip rod, which is arranged within the spring, which is, at least translationally, fixedly connected to the second connection unit and which is adapted to be displaceable relative to the guide tube such that it dips into the guide tube, wherein the dip rod is mounted in a guide bush which, at an end of the guide tube facing away from the first connection unit, is at least partially arranged in the guide tube and which is fixedly connected to the guide tube.

Actuators comprising two telescopically displaceable tubes and surrounded by a spring are well known from prior art. A common problem that occurs, however, is that, due to the connection process between the guide bush and the guide tube, the end of the guide tube connected to the guide bush protrudes from the diameter of the guide bush.

In operation, this protruding edge of the guide tube may damage the surface of the surrounding spring, especially if the spring is coated and/or flocked. The abrasion of the spring coating may, for example, cause noise during operation. Furthermore, damage to the surface of the spring may cause corrosion, which, in turn, can lead to a stress crack and ultimately spring breakage.

In addition, the guide bush may be released from the original position over the life of the actuator due to the action of the spring on the guide tube. As a result, the drive may no longer be watertight, for example, which may cause the drive to fail.

Another disadvantage of current connections between the guide tube and the guide bush in which the guide tube is pressed into the guide bush at specific points, which is also referred to as “cams”, is that any quality assurance relating to this connection must take place via the offset of the end points, which is difficult and costly to measure.

It is therefore the object of the present invention to provide an actuator which can overcome the disadvantages of the prior art and which can provide increased connection strength between the guide tube and the guide bush.

This object is achieved by a generic actuator, which is further characterised in that the guide bush has a peripheral recess in the circumferential direction of the guide bush and in that the guide tube has a tapered end, wherein the tapered end of the guide tube is accommodated in the recess of the guide bush.

Due to the guide bush of the actuator according to the invention, the end of the guide tube adjacent to the guide bush can be peripherally deformed in the recess of the guide bush so that the outer diameter and the inner diameter of the guide tube are tapered towards its end. In this case, the material of the guide tube may be deformed in such a way that a smooth transition between the guide tube and the guide bush is achieved and damage to the surrounding spring can be avoided.

It should be noted at this point that the surrounding spring can, of course, be both a tension spring or a compression spring and that the actuator can be designed as a passive actuator, for example in the form of a piston-cylinder assembly, for example a gas spring, or as an active actuator, for example in the form of a spindle drive.

Due to the fact that the guide bush in the actuator according to the invention is completely connected to the guide tube along the circumferential direction and not only at a plurality of connection points as it was previously, a pull-out force which the guide bush can withstand from the guide tube is significantly increased. If this pull-out force of the guide bush from the guide tube in conventional actuators is around 200 N, the pull-out force of the guide bush from the guide tube may be around 1000 N in an actuator according to the invention.

Advantageously, in the assembled state of the guide bush, a flank of the recess arranged closer to the first connection unit may have a shallower transition from an outer circumference of the guide bush to a bottom of the recess than a flank of the recess arranged further away from the first connection unit. In this way, the tapered end of the guide tube may be fully applied to an outer contour of the guide bush without forming larger or intentionally provided air gaps between the guide tube and the guide bush, i.e. without the guide tube having to follow “hard” shape changes in an outer contour of the guide bush. Notch effects in the material of the guide tube may, for example, be reduced or even avoided by the “gentler” transition.

Here, the transition between the outer circumference of the guide bush and the flank of the recess arranged closer to the first connection unit may have an angle ranging from 10° to 45°, in particular from 20° to 35°. This allows for a gradual transition from the straight portion of the guide tube to the tapered portion of the guide tube which, due to its deformation, follows the outer course of the guide bush. As a result, a weakening or even breakage of the material of the guide tube can be avoided.

Furthermore, the transition between the outer circumference of the guide bush and the flank of the recess arranged further away from the first connection unit may have an angle ranging from 80° to 100°, in particular 90°. By means of this much steeper flank, the end of the guide tube may be provided with a stop against which the tube rests in the connected state.

The connection between the guide tube and guide bush may form a watertight connection. In particular, since the guide tube is circumferentially engaged with the guide bush, a watertight connection between the guide tube and the guide bush may be achieved even without additional sealing elements. Of course, at least one sealing element such as an O-ring may be provided on the guide bush as well.

In one embodiment of the present invention, the guide tube may have at least one radially inwardly pointing projection on its inner circumference which, in the assembled state of the guide bush, rests against an end of the guide bush facing the first connection unit. The projection can prevent the guide bush from being displaced into the guide tube farther up than to the position predefined by the projection before and/or during the deformation of the guide tube. Further, when inserting the guide bush into the guide tube, a predefined mounting position in which the recess coincides in the radial direction with the end of the guide tube can thus be achieved in a simple manner.

In this case, the at least one projection may extend parallel to a longitudinal axis of the guide tube. In this way, the projection can, at the same time, have a function that stabilises the guide tube against bending moments.

Advantageously, the projection may be integrally formed with the guide tube so that a cross-section along the circumferential direction of the guide tube alternately has stronger and weaker wall thicknesses. The integral design of the guide tube with the at least one projection may advantageously affect its manufacturing costs and its stability. The guide tube may thus be designed, for example, as an extrusion profile.

In the recess of the guide bush, at least one radially outwardly pointing projection may be arranged which engages with an inner side of the guide tube and is adapted to prevent a rotation of the guide tube relative to the guide bush. In particular, the projection arranged in the recess of the guide bush may extend over the entire height of the recess but advantageously up to a maximum of half the height of the recess. Here, the at least one projection may connect the two flanks of the recess of the guide bush to each other.

In the assembled state of the guide bush, a portion of the guide bush adjacent to an end of the guide bush facing the first connection unit may have a smaller outer circumference than a portion of the guide bush adjacent to an end of the guide bush facing the second connection unit. The portion of the guide bush which has the larger outer circumference and advantageously connects directly to the flank that forms the stop against the end of the guide tube can thus also form a stop for the guide tube in the still undeformed state.

A portion of the guide tube accommodated in the recess of the guide bush may have a greater wall thickness than a portion of the guide tube surrounding an end of the guide bush facing the first connection unit. This can be caused in particular by the fact that, during the deformation of the guide tube at its end associated with the guide bush, the material of the guide tube is compressed and may even begin to flow due to its reduction in diameter. The deformed end of the guide tube may thus follow on its outside a contour of a forming tool such as a forming jaw, and on its inside the outer contour of the guide bush. In this case, as mentioned above, a gap which remains between the forming tool and the guide bush in the fully approximated state, i.e. at the end of the forming process, may at least partially be greater than the wall thickness of the guide tube in this portion prior to the forming.

Advantageously, the end of the guide tube facing away from the first connection unit in the deformed state may have a smaller outer circumference than a portion of the guide bush adjoining this end of the guide tube. This means that the deformed end of the guide tube may also dip deeper into the recess of the guide bush on its outer side than the portion of the guide bush adjoining the deformed end of the guide tube. This ensures that no edge of the guide tube, which may be made from metal such as aluminium, for example, and which may have sharp edges, projects radially outward on the guide bush. The protection of the surrounding spring from damage by the guide tube can thus be further improved.

The outer circumference of the end of the guide tube facing away from the first connection unit in the deformed state may be substantially uniform along the circumferential direction of the guide tube. As already mentioned above, a complete deformation of the guide tube in the circumferential direction, which produces a peripheral connection of the guide tube with the guide bush, ensures that all end portions of the guide tube, in particular a peripheral outer edge of the tube end, from the adjoining portion of the guide bush projected beyond a radial direction so that the spring cannot be damaged by the guide tube.

Further, the guide bush at its end facing the first connection unit in the assembled state of the guide bush may comprise a chamfer around the outer circumference. This chamfer may facilitate an insertion of the guide bush into the guide tube. The chamfer may, for example, facilitate an insertion of the guide bush into the guide tube when the outer diameter of the portion of the guide bush to be inserted into the guide tube is, in the undeformed state, greater than an inner diameter of the guide tube.

The guide bush may be formed, for example, from a plastic, in particular from PE, POM, or PA. The guide bush may also be designed as an injection-moulded part whereby the manufacturing costs of the guide bush and thus of the actuator according to the invention may be reduced. Due to the softer material of the guide bush compared to the material of the guide tube, damage to this spring may be avoided when the guide bush is in contact with the surrounding spring.

The actuator according to the invention will be described below in more detail on the basis of an embodiment with reference to the accompanying drawings, in which

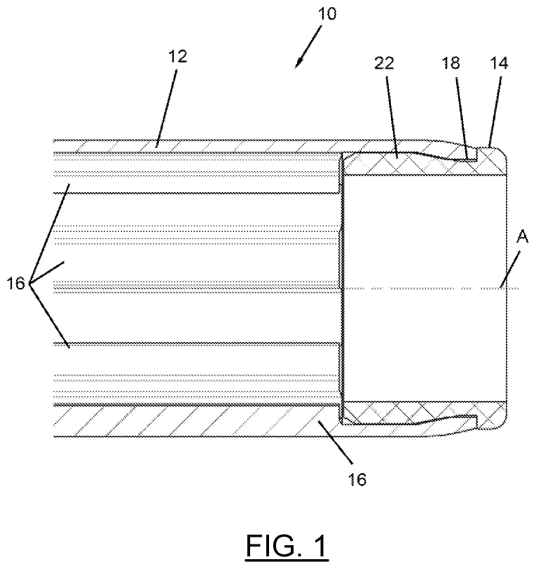

FIG. 1 is a cross-sectional side view of one end of a guide tube of an actuator according to the invention, and

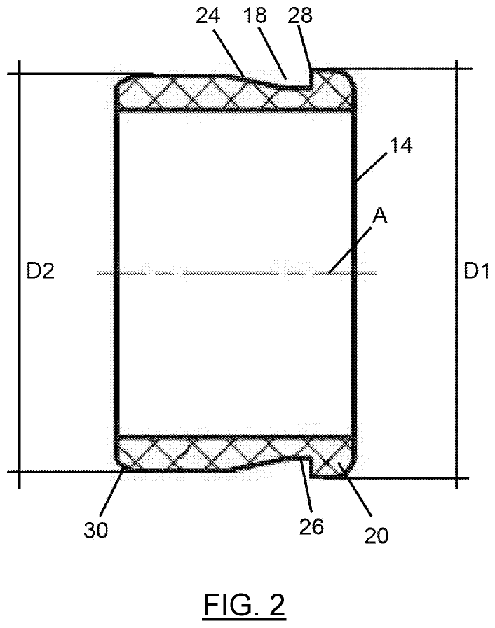

FIG. 2 is a cross-sectional side view of a guide bush according to the present invention.

FIG. 1 shows a portion of an actuator according to the invention generally designated with the numeral 10 in a cross-sectional side view. The actuator 10 comprises a guide tube 12 and a guide bush 14. The guide bush 14 is inserted into an open end of the guide tube 12 until a portion of the guide bush 14, which will be described in detail below, abuts against the free end of the guide tube 12.

As can be seen in the section from FIG. 1, the guide tube 12 comprises on its inner side a plurality of projections 16 which extend here parallel to a central axis A of the guide tube 12 and the guide bush 14.

The end of the guide tube 12 associated with the guide bush 14 is formed such that it engages in a recess 18 of the guide bush 14 (see also FIG. 2). It can also be seen that an outer circumference of the deformed end of the guide tube 12 forms a smooth transition to a portion 20 of the guide bush 14 adjoining this end of the guide tube 12 (see FIG. 2). That means that there is no edge of the end of the guide tube 12 that protrudes farther radially outward than the portion 20 of the guide bush 14.

It can also be seen in FIG. 1 that the deformed portion of the guide tube 12 has a greater wall thickness than a portion of the guide tube 12 surrounding a portion 22 of the guide bush 14 arranged deeper in the guide tube 12.

The guide tube 12 facing away from the end of the guide bush 14 here has a rounded outer edge to protect a spring (not shown) surrounding the guide tube 12 and the guide bush 14 from damage caused by contact with the guide bush 14.

In FIG. 2, the guide bush 14 is now shown separately, that is, without guide tube 12, as a section. It can be seen that the recess 18 has a first flank 24, which is arranged deeper in the guide tube 12 (see FIG. 1), which forms a gradual transition between the section 22 of the guide bush 14 and a bottom 26 of the recess 18. At the end of the bottom 26 of the recess 18 opposite of the first flank 24 of the recess 18, a second flank 28 is arranged, which here runs substantially parallel to the bottom 26 of the recess 18 at a right angle, which here means in a radial direction of the guide bush 14.

The portion 20 of the guide bush 14 has an outer diameter D1 which is greater than an outer diameter D2 of the portion 22 of the guide bush 14. As already explained above, this allows the portion 20, in particular the second flank 28, of the guide bush 14 to provide a stop to the end of the guide tube 12 which is to be connected to the guide bush 14, both in the undeformed and in the deformed state of the guide tube 12.

On its inner side, the guide bush 14 has a central through hole which serves to guide a dip rod, not shown.

At its end to be inserted into the guide tube 12, the guide bush 14 has a chamfer 30 which runs around the outer circumference and which serves to facilitate the insertion of the guide bush 14 into the guide tube 12.

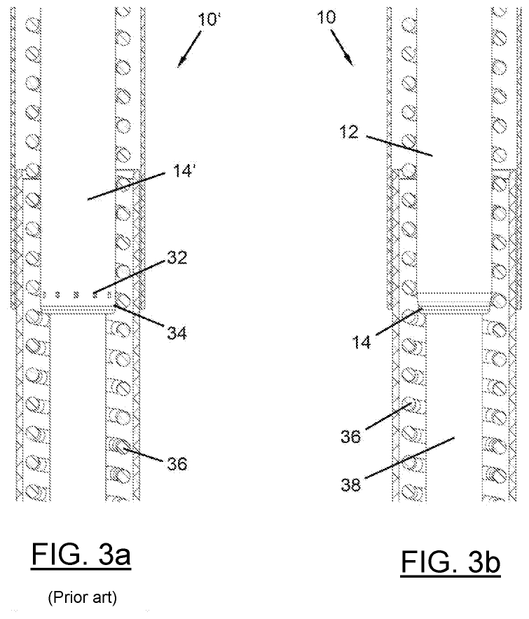

FIGS. 3a and 3b show a comparison of a prior art actuator 10′ and an actuator 10 according to the present invention. It can be seen in FIG. 3a that the guide tube 14′ of the prior art has a plurality of inwardly pressed connection points 32. As a result, the free end 34 of the guide tube 14′ can be slightly curved outward so that a spring 36 surrounding the guide tube 14′ may be damaged.

The actuator 10 according to the invention shown in FIG. 3b comprises the guide tube 12 and the guide bush 14, as described in particular with reference to FIG. 1. The guide tube 12 is also surrounded by a spring 36, which is formed here as a compression spring. Furthermore, a dip tube 38 is connected with the guide bush 14, which is slidably mounted on the guide bush 14 and which can dip into the guide tube 12.

Compared to the actuator 10′ of FIG. 3a, it can be clearly seen in the actuator 10 of FIG. 3b that the free end of the guide tube 12 associated with the guide bush 14 has a shape tapering towards the dip tube 38 due to the inventive manner of connecting the guide tube 12 to the guide bush 14. This shape prevents portions of the guide tube 12 from protruding radially outward so that damage to the spring can be reliably prevented.

1. An actuator comprising:
a first connection unit for connecting the actuator to a first parent assembly;
a second connection unit for connecting the actuator to a second parent assembly;
a spring arranged between the first and the second connection unit whose length is variable depending on a change in a distance between the first connection unit and the second connection unit;
a guide tube which is arranged within the spring and, at least translationally, fixedly connected to the first connection unit; and
a dip rod, which is arranged within the spring which is, at least translationally, fixedly connected to the second connection unit and which is adapted to be displaceable relative to the guide tube such that it dips into the guide tube, wherein the dip rod is mounted in a guide bush which, at an end of the guide tube facing away from the first connection unit, is at least partially arranged in the guide tube and which is fixedly connected to the guide tube, characterised in that the guide bush comprises a recess running in a circumferential direction of the guide bush and that the guide tube comprises a tapering end wherein the tapering end of the guide tube is accommodated in the recess of the guide bush.

2. The actuator according to claim 1, characterised in that a flank of the recess of the guide bush arranged closer to the first connection unit has a shallower transition from an outer circumference of the guide bush to a bottom of the recess than a flank of the recess arranged farther away from the first connection unit.

3. The actuator according to claim 2, characterised in that the transition between the outer circumference of the guide bush and the flank of the recess arranged closer to the first connection unit has an angle ranging from 10° to 45°, in particular from 20° to 35°.

4. The actuator according to claim 2, characterised in that the transition between the outer circumference of the guide bush and the flank of the recess arranged farther away from the first connection unit has an angle ranging from 80° to 100°, in particular 90°.

5. The actuator according to claim 1, characterised in that the guide tube has on its inner circumference at least one radially inwardly pointing projection.

6. The actuator according to claim 5, characterised in that the at least one projection extends parallel to a longitudinal axis of the guide tube.

7. The actuator according to claim 5, characterised in that the projection is integrally formed with the guide tube.

8. The actuator according to claim 1, characterised in that in the recess of the guide bush, at least one radially outwardly pointing projection is arranged which engages with an inner side of the guide tube and which is adapted to prevent a rotation of the guide tube relative to the guide bush.

9. The actuator according to claim 1, characterised in that a portion of the guide bush adjacent to an end of the guide bush facing the first connection unit has a smaller outer circumference than a portion of the guide bush adjacent to an end of the guide bush facing the second connection unit.

10. The actuator according to claim 1, characterised in that a portion of the guide tube accommodated in the recess of the guide bush has a greater wall thickness than a portion of the guide tube surrounding an end of the guide bush facing the first connection unit.

11. The actuator according to claim 1, characterised in that the end of the guide tube facing away from the first connection unit has a smaller outer circumference than a portion of the guide bush adjoining this end of the guide tube.

12. The actuator according to claim 1, characterised in that an outer circumference of the end of the guide tube facing away from the first connection unit is substantially uniform along the circumferential direction of the guide tube.

13. The actuator according to claim 1, characterised in that the guide bush comprises at its end facing the first connection unit a chamfer running around an outer circumference.

14. The actuator according to claim 1, characterised in that the guide bush is formed from a plastic, in particular of PE, POM, or PA.
